(19) United States
(12) Patent Application Publication
(10) Pub. No.: US 2020/0198253 A1
(43) Pub. Date: Jun. 25, 2020

(54) HIGH-STRENGTH CUT-PROOF PVC COMPOSITE MATERIALS

(71) Applicant: Guangzhou Plato Plastic Co., Ltd., Guangzhou (CN)

(72) Inventors: Shie Poen LIAW, Guangzhou (CN); Hongjun QI, Guangzhou (CN)

(21) Appl. No.: 16/567,113

(22) Filed: Sep. 11, 2019

(30) Foreign Application Priority Data
Dec. 20, 2018 (CN) 201811565129.1

(51) Int. Cl. B29C 65/02; B29C 65/00; B29C 45/14

(52) U.S. Cl. CPC B29C 65/02; B29B 13/022; B29C 45/14467; B29C 66/72321

(57) ABSTRACT

Disclosed is a PVC composite material, and more particularly is a high-strength cut-proof PVC composite material, including a PVC film and a steel wire mesh. The PVC film is laminated to upper and lower surfaces of the steel wire mesh by hot pressing. The PVC film is prepared from 45-55 parts by weight of suspension polyvinyl chloride resin powder, 24-28 parts by weight of diisononyl phthalate, 4.5-7 parts by weight of dioctyl adipate, 1.0-2.5 parts by weight of epoxidized soybean oil, 1.0-2.5 parts by weight of liquid barium-zinc stabilizer, 10-15 parts by weight of activated light calcium carbonate, 0.15-0.25 part by weight of anti-mildew agent and 1.5-2.2 parts by weight of organic pigments. The PVC composite material of the invention is produced by the lamination of the PVC film to the ultra high-strength steel wire mesh.

### CROSS-REFERENCE TO RELATED APPLICATIONS

This application claims the benefit of priority from Chinese Patent Application No. 201811565129.1, filed on Dec. 20, 2018. The content of the aforementioned application, including any intervening amendments thereto, is incorporated herein by reference in its entirety.

### TECHNICAL FIELD

The application relates to PVC composite materials, and more particularly to a high-strength cut-proof PVC composite material.

### BACKGROUND OF THE INVENTION

PVC material is one of the most widely used plastic materials due to its excellent flame retardancy, strength, weatherability and geometric stability. Various fibers are often compounded in the PVC composite materials to improve the tensile strength and brittleness of PVC. However, there are still some defects in the existing PVC composite materials, such as poor resistance to cut and stab, thereby failing to effectively mitigate the damages caused by an edge tool such as knife and dagger.

### SUMMARY OF THE INVENTION

The invention provides a high-strength cut-proof PVC composite material by combining a PVC film and an ultra high-strength steel wire mesh to overcome the defects in the prior art. The PVC composite material of the invention has excellent resistance to cut, abrasion and stab, thereby effectively avoiding the damage caused by edge tools such as knives and daggers. Meanwhile, the PVC composite material also has good resistance to water, acid, alkali and ultraviolet.

The technical solutions of the invention are described as follows.

This application provides a high-strength cut-proof PVC composite material, comprising a PVC film and a steel wire mesh, and the PVC film is laminated to upper and lower surfaces of the steel wire mesh by hotpressing.

In an embodiment, the PVC film is prepared from 45-55 parts by weight of suspension polyvinyl chloride resin powder, 24-28 parts by weight of diisononyl phthalate, 4.5-7 parts by weight of dioctyl adipate, 1.0-2.5 parts by weight of epoxidized soybean oil, 1.0-2.5 parts by weight of a liquid barium-zinc stabilizer, 10-15 parts by weight of an activated light calcium carbonate, 0.15-0.25 part by weight of an anti-mildew agent and 1.5-2.2 parts by weight of organic pigments.

In an embodiment, a method of preparing the PVC film comprises the following steps:

(1) adding 45-55 parts by weight of suspension polyvinyl chloride resin powder, 24-28 parts by weight of diisononyl phthalate, 4.5-7 parts by weight of dioctyl adipate, 1.0-2.5 parts by weight of epoxidized soybean oil, 1.0-2.5 parts by weight of the liquid barium-zinc stabilizer, 10-15 parts by weight of the activated light calcium carbonate, 0.15-0.25 part by weight of the anti-mildew agent and 1.5-2.2 parts by weight of the organic pigments to a high-speed blender, stirring the reaction mixture at 100-140° C. for 10-15 min to obtain a melted mixture; (2) filtering the melted mixture obtained in step (1) through a 150-mesh sieve to obtain a filtered material A;

(3) injecting the filtered material A obtained in step (2) into a high-temperature rolling furnace; and rolling the filtered material A at 160-180° C. and 60 Mpa for 3 h to obtain a product B; and

(4) calendering the product B obtained in step (3) by a calender to form the PVC film with a thickness of 5-10 mm; wherein a screw temperature is 220-240° C.; a conveying section temperature is 230-250° C.; an extrusion pressure is 50-60 MPa; a drying temperature is 80-100° C.; a drying time is 4-6 h; and a production speed is 5-30 m/min.

In an embodiment, a method of preparing the PVC composite material comprises the following steps:

(1) adding 45-55 parts by weight of suspension polyvinyl chloride resin powder, 24-28 parts by weight of diisononyl phthalate, 4.5-7 parts by weight of dioctyl adipate, 1.0-2.5 parts by weight of epoxidized soybean oil, 1.0-2.5 parts by weight of the liquid barium-zinc stabilizer, 10-15 parts by weight of the activated light calcium carbonate, 0.15-0.25 part by weight of the anti-mildew agent and 1.5-2.2 parts by weight of the organic pigments to the high-speed blender, stirring the reaction mixture at 100-140° C. for 10-15 min, discharging the reaction mixture into a low-speed cold mixing pot; dispersing the reaction mixture and cooling the reaction mixture to 23° C.; and discharging the cooled mixture into a storage tank;

(2) filtering the cooled mixture obtained in step (1) through a sieve to obtain a mushy slurry;

(3) cooling the mushy slurry obtained in step (2) in a cooling machine at −20-10° C. for 10-20 min;

(4) granulating the cooled product obtained in step (3) with a granulator, and bagging the granulated product for use;

(5) transferring the granulated product obtained in step (4) to a twin-screw extruder for extrusion; wherein the twin-screw extruder has a maximum temperature of 180-200° C., and a screw rotation speed of the twin-screw extruder is controlled at 30-40 rpm;

(6) placing the steel wire mesh below the twin-screw extruder, where the steel wire mesh is supported by a support frame; extruding the slurry obtained in step (5) under high pressure; laminating the extruded slurry on the upper surface of the steel wire mesh and reversing the steel wire mesh for laminating on the lower surface; repeating the laminating three times for each surface; and subjecting the resulting steel wire mesh to cold forming by a cooling fan at 23-26° C. to obtain a laminated steel wire mesh;

(7) preheating the upper and lower surfaces of the laminated steel wire mesh obtained in step (6) sufficiently, then placing two PVC films on the upper and lower surfaces of the laminated steel wire mesh, respectively; then subjecting the PVC films and the laminated steel wire mesh to hot pressing lamination by a hot pressing device followed by cooling to obtain a semi-finished PVC composite material; wherein the hot-pressing lamination is performed at 3-5 Mpa and 160° C.;

(8) embossing the upper and lower surfaces of the semi-finished PVC composite material obtained in step (7) with an embossing roller of an embossing machine to obtain an embossed PVC composite material; and cooling and shaping the embossed PVC composite material sufficiently with a cooling roller; wherein the embossing roller is driven by an oil pressure at 3-5 Mpa; and

(9) inspecting and rolling the PVC composite material obtained in step (8) to obtain a finished product.

The present invention has the following beneficial effects.

The high-strength cut-proof PVC composite material provided herein is produced by combining a PVC film and an ultra-high-strength steel wire mesh, so that the PVC composite material has excellent resistance to cut, abrasion and stab, capable of effectively reducing the damage caused by edge tools such as knives and daggers. Moreover, the PVC composite material also has desirable resistance to water, acid, alkali and ultraviolet.

### DETAILED DESCRIPTION OF EMBODIMENTS

### Example 1

A high-strength cut-proof PVC composite material included a PVC film and a steel wire mesh, where the PVC film was laminated to upper and lower surfaces of the steel wire mesh by hotpressing.

The PVC film was prepared from 45 parts by weight of suspension polyvinyl chloride resin powder, 24 parts by weight of diisononyl phthalate, 4.5 parts by weight of dioctyl adipate, 1.0 part by weight of epoxidized soybean oil, 1.0 part by weight of a liquid barium-zinc stabilizer, 10 parts by weight of an activated light calcium carbonate, 0.15 part by weight of an anti-mildew agent and 1.5 parts by weight of organic pigments.

The PVC film was specifically prepared as follows.

Step (A1) Mixing

45 parts by weight of suspension polyvinyl chloride resin powder, 24 parts by weight of diisononyl phthalate, 4.5 parts by weight of dioctyl adipate, 1.0 part by weight of epoxidized soybean oil, 1.0 part by weight of the liquid barium-zinc stabilizer, 10 parts by weight of the activated light calcium carbonate, 0.15 part by weight of the anti-mildew agent and 1.5 parts by weight of the organic pigments-were mixed in a high-speed blender and stirred at 100° C. for 10 min to obtain a melted mixture.

Step (A2) Filtering

The melted mixture obtained in step (A1) was filtered through a 150-mesh sieve to obtain a filtered material A.

Step (A3) High-Temperature Rolling

The filtered material A obtained in step (A2) was injected into a high-temperature rolling furnace and rolled at 160° C. and 60 MPa for 3 h to obtain a product B.

Step (A4) Calendering

The product B obtained in step (A3) was calendered by a calender to produce the PVC film with a thickness of 5 mm, where a screw temperature was 220° C.; a conveying section temperature was 230° C.; an extrusion pressure was 50 MPa; a drying temperature was 80° C.; a drying time was 4 h; and a production speed was 5 m/min.

The PVC composite material was specifically prepared as follows.

Step (B1) High-Speed Mixing and Stirring

45 parts by weight of suspension polyvinyl chloride resin powder, 24 parts by weight of diisononyl phthalate, 4.5 parts by weight of dioctyl adipate, 1.0 part by weight of epoxidized soybean oil, 1.0 part by weight of the liquid barium-zinc stabilizer, 10 parts by weight of the activated light calcium carbonate, 0.15 part by weight of the anti-mildew agent and 1.5 parts by weight of the organic pigments were added to a high-speed blender and stirred at 100° C. for 10 min. Then the reaction mixture was discharged into a low-speed cold mixing pot, dispersed and cooled to 23° C. The cooled mixture was discharged into a storage tank.

Step (B2) Filtering

The cooled mixture obtained in step (B1) was filtered through a sieve to obtain a mushy slurry.

Step (B3) Cooling

The slurry obtained in step (B2) was cooled in a cooling machine at −20° C. for 10 min.

Step (B4) Granulation

The cooled product obtained in step (B3) was granulated by a granulator, and the granulated product was bagged for use.

Step (B5) Twin-Screw Extrusion

The granulated product obtained in step (B4) was transferred to a twin-screw extruder for extrusion, where the twin-screw extruder had a maximum temperature of 180° C., and a screw rotation speed of the twin-screw extruder was controlled at 30 rpm.

Step (B6) Lamination

The steel wire mesh was placed below the twin-screw extruder, where the steel wire mesh was supported by a support frame. The slurry obtained in step (B5) was extruded under high pressure, and then laminated on the upper surface of the steel wire mesh. The steel wire mesh was reversed for lamination on the lower surface. The lamination was repeated three times for each surface. The resulting steel wire mesh was subjected to cold forming by a cooling fan at 23° C. to obtain a laminated steel wire mesh.

Step (B7) Lamination of the PVC Film to the Steel Wire Mesh

The upper and lower surfaces of the laminated steel wire mesh obtained in step (B6) were sufficiently preheated, and were respectively covered with the PVC film obtained in step (A4). Then the PVC film and the laminated steel wire mesh were subjected to hot pressing lamination by a hot pressing device and cooled to obtain a semi-finished PVC composite material, where the hot pressing lamination was performed at 3-5 Mpa and 160° C.

Step (B8) Embossing

The upper and lower surfaces of the semi-finished PVC composite material obtained in step (B7) was embossed with an embossing roller of an embossing machine to obtain an embossed PVC composite material. The embossed PVC composite material was fully cooled and shaped by a cooling roller, where the embossing roller was driven by an oil pressure at 3 Mpa.

Step (B9) Rolling and Packaging

The PVC composite material obtained in step (B8) was inspected and rolled to produce a finished product.

### Example 2

A high-strength cut-proof PVC composite material included a PVC film and a steel wire mesh, and the PVC film was laminated to upper and lower surfaces of the steel wire mesh by hot pressing.

The PVC film was prepared from 50 parts by weight of suspension polyvinyl chloride resin powder, 26 parts by weight of diisononyl phthalate, 5.5 parts by weight of dioctyl adipate, 1.8 parts by weight of epoxidized soybean oil, 1.8 parts by weight of a liquid barium-zinc stabilizer, 12 parts by weight of an activated light calcium carbonate, 0.2 part by weight of an anti-mildew agent and 1.9 parts by weight of organic pigments.

The PVC film was specifically prepared as follows.

Step (A1) Mixing

50 parts by weight of suspension polyvinyl chloride resin powder, 26 parts by weight of diisononyl phthalate, 5.5 parts by weight of dioctyl adipate, 1.8 parts by weight of epoxidized soybean oil, 1.8 parts by weight of the barium-zinc stabilizer, 12 parts by weight of the activated light calcium carbonate, 0.2 part by weight of the anti-mildew agent and 1.9 parts by weight of the organic pigments were mixed in a high-speed blender and stirred at 120° C. for 13 min to obtain a melted mixture.

Step (A2) Filtering

The melted mixture obtained in step (A1) was filtered through a 150-mesh sieve to obtain a filtered material A.

Step (A3) High-Temperature Rolling

The filtered material A obtained in step (A2) was injected into a high-temperature rolling furnace and rolled at 170° C. and 60 MPa for 3 h to obtain a product B.

Step (A4) Calendering

The product B obtained in step (A3) was calendered by a calender to produce the PVC film with a thickness of 7 mm, where a screw temperature was 225° C.; a conveying section temperature was 240° C.; an extrusion pressure was 55 Mpa; a drying temperature was 90° C.; a drying time was 5 h; and a production speed was 20 m/min.

The PVC composite material was specifically prepared as follows.

Step (B1) High-Speed Mixing and Stirring

50 parts by weight of suspension polyvinyl chloride resin powder, 26 parts by weight of diisononyl phthalate, 5.5 parts by weight of dioctyl adipate, 1.8 parts by weight of epoxidized soybean oil, 1.8 parts by weight of the liquid barium-zinc stabilizer, 12 parts by weight of the activated light calcium carbonate, 0.2 part by weight of the anti-mildew agent and 1.9 parts by weight of the organic pigments were added to a high-speed blender and stirred at 120° C. for 12 min. Then the reaction mixture was discharged into a low-speed cold mixing pot, dispersed and cooled to 24° C. The cooled mixture was discharged into a storage tank.

Step (B2) Filtering

The cooled mixture obtained in step (B1) was filtered through a sieve to obtain a mushy slurry.

Step (B3) Cooling

The slurry obtained in step (B2) was cooled in a cooling machine at 0° C. for 15 min.

Step (B4) Granulation

The cooled product obtained in step (B3) was granulated by a granulator, and the granulated product was bagged for use.

Step (B5) Twin-Screw Extrusion

The granulated product obtained in step (B4) was transferred to a twin-screw extruder for extrusion, where the twin-screw extruder had a maximum temperature of 190° C., and a screw rotation speed of the twin-screw extruder was controlled at 35 rpm.

Step (B6) Lamination

The steel wire mesh was placed below the twin-screw extruder, where the steel wire mesh was supported by a support frame. The slurry obtained in step (B5) was extruded under high pressure, and then laminated on the upper surface of the steel wire mesh. The steel wire mesh was reversed for lamination on the lower surface. The lamination was repeated three times for each surface. The resulting steel wire mesh was subjected to cold forming by a cooling fan at 24° C. to obtain a laminated steel wire mesh.

Step (B7) Lamination of the PVC Film to the Steel Wire Mesh

The upper and lower surfaces of the laminated steel wire mesh obtained in step (B6) were sufficiently preheated, and were respectively covered with the PVC film obtained in step (A4). Then the PVC film and the laminated steel wire mesh were subjected to hot pressing lamination by a hot pressing device and cooled to obtain a semi-finished PVC composite material, where the hot pressing lamination was performed at 4 Mpa and 170° C.

Step (B8) Embossing

The upper and lower surfaces of the semi-finished PVC composite material obtained in step (B7) was embossed with an embossing roller of an embossing machine to obtain an embossed PVC composite material. The embossed PVC composite material was fully cooled and shaped by a cooling roller, where the embossing roller was driven by an oil pressure at 4 Mpa.

Step (B9) Rolling and Packaging

The PVC composite material obtained in step (B8) was inspected and rolled to produce a finished product.

### Example 3

A high-strength cut-proof PVC composite material included a PVC film and a steel wire mesh, where the PVC film was laminated to upper and lower surfaces of the steel wire mesh by hot pressing.

The PVC film was prepared from 55 parts by weight of suspension polyvinyl chloride resin powder, 28 parts by weight of diisononyl phthalate, 7 parts by weight of dioctyl adipate, 2.5 parts by weight of epoxidized soybean oil, 2.5 parts by weight of a liquid barium-zinc stabilizer, 15 parts by weight of an activated light calcium carbonate, 0.25 part by weight of an anti-mildew agent and 2.2 parts by weight of organic pigments.

The PVC film was specifically prepared as follows.

Step (A1) Mixing

55 parts by weight of suspension polyvinyl chloride resin powder, 28 parts by weight of diisononyl phthalate, 7 parts by weight of dioctyl adipate, 2.5 parts by weight of epoxidized soybean oil, 2.5 parts by weight of the liquid barium-zinc stabilizer, 15 parts by weight of the activated light calcium carbonate, 0.25 part by weight of the anti-mildew agent and 2.2 parts by weight of the organic pigments were mixed in a high-speed blender and stirred at 140° C. for 15 min to obtain a melted mixture.

Step (A2) Filtering

The melted mixture obtained in step (A1) was filtered through a 150-mesh sieve to obtain a filtered material A.

Step (A3) High-Temperature Rolling

The filtered material A obtained in step (A2) was injected into a high-temperature rolling furnace and rolled at 180° C. and 60 Mpa for 3 h to obtain a product B.

Step (A4) Calendering

The product B obtained in step (A3) was calendered by a calender to produce the PVC film with a thickness of 10 mm, where a screw temperature was 240° C.; a conveying section temperature was 250° C.; an extrusion pressure was 60 Mpa; a drying temperature was 100° C.; a drying time was 6 h; and a production speed was 30 m/min.

The PVC composite material was specifically prepared as follows.

Step (B1) High-Speed Mixing and Stirring

55 parts by weight of suspension polyvinyl chloride resin powder, 28 parts by weight of diisononyl phthalate, 7 parts by weight of dioctyl adipate, 2.5 parts by weight of epoxidized soybean oil, 2.5 parts by weight of the liquid barium-zinc stabilizer, 15 parts by weight of the activated light calcium carbonate, 0.25 part by weight of the anti-mildew agent and 2.2 parts by weight of the organic pigments were added to a high-speed blender and stirred at 140° C. for 15 min. Then the reaction mixture was discharged into a low-speed cold mixing pot, dispersed and cooled to 26° C. The cooled mixture was discharged into a storage tank.

Step (B2) Filtering

The cooled mixture obtained in step (B1) was filtered through a sieve to obtain a mushy slurry.

Step (B3) Cooling

The slurry obtained in step (B2) was cooled in a cooling machine at 10° C. for 20 min.

Step (B4) Granulation

The cooled product obtained in step (B3) was granulated by a granulator, and the granulated product was bagged for use.

Step (B5) Twin-Screw Extrusion

The granulated product obtained in step (B4) was transferred to a twin-screw extruder for extrusion, where the twin-screw extruder had a maximum temperature of 200° C., and a screw rotation speed of the twin-screw extruder was controlled at 40 rpm.

Step (B6) Lamination

The steel wire mesh was placed below the twin-screw extruder, where the steel wire mesh was supported by a support frame. The slurry obtained in step (B5) was extruded under high pressure, and then laminated on the upper surface of the steel wire mesh. The steel wire mesh was reversed for lamination on the lower surface. The lamination was repeated three times for each surface. The resulting steel wire mesh was subjected to cold forming by a cooling fan at 26° C. to obtain a laminated steel wire mesh.

Step (B7) Lamination of the PVC Film to the Steel Wire Mesh

The upper and lower surfaces of the laminated steel wire mesh obtained in step (B6) were sufficiently preheated, and were respectively covered with the PVC film obtained in step (A4). Then the PVC film and the laminated steel wire mesh were subjected to hot pressing lamination by a hot pressing device and cooled to obtain a semi-finished PVC composite material, where the hot pressing lamination was performed at 5 Mpa and 180° C.

Step (B8) Embossing

The upper and lower surfaces of the semi-finished PVC composite material obtained in step (B7) was embossed with an embossing roller of an embossing machine to obtain an embossed PVC composite material. The embossed PVC composite material was fully cooled and shaped by a cooling roller, where the embossing roller was driven by an oil pressure at 5 Mpa.

Step (B9) Rolling and Packaging

The PVC composite material obtained in step (B8) was inspected and rolled to produce a finished product.

### Example 4: Performance Index of High Strength Cut-Proof PVC Composite Material of the Invention

A commercially-available ordinary PVC composite material was used as a comparative example, and the PVC composite materials prepared in Examples 1-3 and the comparative example were respectively measured for mechanical properties and stabilities. The results were shown in Table 1.

TABLE 1
Performances of high-strength cut-proof PVC composite materials prepared in exmaples

| | | | | Comparative |
|---|---|---|---|---|
| Index | Example 1 | Example2 | Example3 | Example |
| UV-Resistance | No penetration | | | No penetration |
| Tensile Load | 1100 | 1200 | 1150 | 950 |
| (N/5 cm) | | | | |
| Tearing Load (N) | 340 | 350 | 344 | 280 |
| Peeling Strength | 72 | 73.5 | 73 | 65 |
| (N/5 cm) | | | | |
| PenetrationResistance | 24-h | 24-h | 24-h | 12-h |
| | waterresistance | waterresistance | waterresistance | waterresistance |
| | (0.3 MPa) | (0.3 MPa) | (0.3 MPa) | (0.3 MPa) |
| Perforation | Impervious | | | Impervious |
| Resistance | | | | |
| Low-Temperature | Fissureless (−20° C.) | Fissureless (−20° C.) | Fissureless (−20° C.) | Fissureless (−10° C.) |
| Bending Properly | | | | |
| Flame Retardancy | NFP92-507: 2004 | NFP92-507: 2004 | NFP92-507: 2004 | NFP92-507: 2004 |
| | M2 | M2 | M2 | M3 |
| Corrosion | Resistance to HCl | Resistance to HCl | Resistance to HCl | Resistance to HCl |
| Resistance | and NaOH | and NaOH | and NaOH | and NaOH |

It can be seen from Table 1 that the high-strength cut-proof PVC composite material prepared in Example 1 had a tensile load of 1100 N/5 cm, a tearing load of 340 N and a peeling strength of 72 N/5cm; the high-strength cut-proof PVC composite material prepared in Example 2 had a tensile load of 1200 N/5 cm, a tearing load of 350 N and a peeling strength of 73.5 N/5 cm; and the high-strength cut-proof PVC composite material prepared in Example 3 had a tensile load of 1150 N/5 cm, a tearing load of 344 N and a peeling strength of 73 N/5 cm. Therefore, the high-strength cut-proof PVC composite material prepared in Example 2 had the best tensile load, tearing load and peeling strength. In addition, the high-strength cut-proof PVC composite materials prepared in Examples 1-3 all had better UV-resistance, perforation resistance and low-temperature bending property, flame retardancy and corrosion resistance, and they were harmless to the environment and human body during the production and use. By contrast, the commercially available ordinary PVC composite material was far lower than the high-strength cut-proof PVC composite materials prepared in Examples 1-3 in tensile load, tearing load and peeling strength, and the commercially available ordinary PVC composite material also had inferior penetration resistance, low-temperature bending property, and flame retardancy.

The above embodiments and the description are merely illustrative of the principles and optimal embodiments of the invention. Various changes and modifications made without departing from the spirit of the invention should fall within the scope of the invention.

What is claimed is:

1. A PVC composite material, comprising a PVC film and a steel wire mesh; wherein the PVC film is laminated to upper and lower surfaces of the steel wire mesh by hot pressing.

2. The PVC composite material of claim 1, wherein the PVC film is prepared from 45-55 parts by weight of suspension polyvinyl chloride resin powder, 24-28 parts by weight of diisononyl phthalate, 4.5-7 parts by weight of dioctyl adipate, 1.0-2.5 parts by weight of epoxidized soybean oil, 1.0-2.5 parts by weight of a liquid barium-zinc stabilizer, 10-15 parts by weight of an activated light calcium carbonate, 0.15-0.25 part by weight of an anti-mildew agent and 1.5-2.2 parts by weight of organic pigments.

3. The PVC composite material of claim 2, wherein a method of preparing the PVC film comprises the following steps:
(1) adding 45-55 parts by weight of suspension polyvinyl chloride resin powder, 24-28 parts by weight of diisononyl phthalate, 4.5-7 parts by weight of dioctyl adipate, 1.0-2.5 parts by weight of epoxidized soybean oil, 1.0-2.5 parts by weight of the liquid barium-zinc stabilizer, 10-15 parts by weight of the activated light calcium carbonate, 0.15-0.25 part by weight of the anti-mildew agent and 1.5-2.2 parts by weight of the organic pigments to a high-speed blender; and stirring the reaction mixture at 100-140° C. for 10-15 min to obtain a melted mixture;
filtering the melted mixture obtained in step (1) through a 150-mesh sieve to obtain a filtered material A;
injecting the filtered material A obtained in step (2) into a high-temperature rolling furnace; and rolling the filtered material A at 160-180° C. and 60 MPa for 3 h to obtain a product B; and
calendering the product B obtained in step (3) by a calender to form the PVC film with a thickness of 5-10 mm; wherein a screw temperature is 220-240° C.; a conveying section temperature is 230-250° C.; an extrusion pressure is 50-60 MPa; a drying temperature is 80-100° C.; a drying time is 4-6 h; and a production speed is 5-30 m/min.

4. The PVC composite material of claim 1, wherein a method of preparing the PVC composite material comprises the following steps:
(1) adding 45-55 parts by weight of suspension polyvinyl chloride resin powder, 24-28 parts by weight of diisononyl phthalate, 4.5-7 parts by weight of dioctyl adipate, 1.0-2.5 parts by weight of epoxidized soybean oil, 1.0-2.5 parts by weight of a liquid barium-zinc stabilizer, 10-15 parts by weight of an activated light calcium carbonate, 0.15-0.25 part by weight of an anti-mildew agent and 1.5-2.2 parts by weight of organic pigments to a high-speed blender; stirring the reaction mixture at 100-140° C. for 10-15 min; discharging the reaction mixture into a low-speed cold mixing pot; dispersing the reaction mixture and cooling the reaction mixture to 23° C.; and discharging the cooled mixture into a storage tank;
(2) filtering the cooled mixture obtained in step (1) through a sieve to obtain a mushy slurry;
(3) cooling the mushy slurry obtained in step (2) in a cooling machine at −20-10° C. for 10-20 min;
(4) granulating the cooled product obtained in step (3) with a granulator, and bagging the granulated product for use;
(5) transferring the granulated product obtained in step (4) to a twin-screw extruder for extrusion; wherein the twin-screw extruder has a maximum temperature of 180-200° C., and a screw rotation speed of the twin-screw extruder is controlled at 30-40 rpm;
(6) placing the steel wire mesh below the twin-screw extruder, wherein the steel wire mesh is supported by a support frame; extruding the slurry obtained in step (5) under high pressure; laminating the extruded slurry on the upper surface of the steel wire mesh and reversing the steel wire mesh for laminating on the lower surface; repeating the laminating three times for each surface; and subjecting the resulting steel wire mesh to cold forming by a cooling fan at 23-26° C. to obtain a laminated steel wire mesh;
(7) preheating the upper and lower surfaces of the laminated steel wire mesh obtained in step (6) sufficiently, then placing two PVC films on the upper and lower surfaces of the laminated steel wire mesh, respectively; then subjecting the PVC films and the laminated steel wire mesh to hot pressing lamination by a hot pressing device followed by cooling to obtain a semi-finished PVC composite material; wherein the hot-pressing lamination is performed at 3-5 Mpa and 160° C.;
(8) embossing the upper and lower surfaces of the semi-finished PVC composite material obtained in step (7) with an embossing roller of an embossing machine to obtain an embossed PVC composite material; and cooling and shaping the embossed PVC composite material sufficiently with a cooling roller; wherein the embossing roller is driven by an oil pressure at 3-5 Mpa; and
(9) inspecting and rolling the PVC composite material obtained in step (8) to obtain a finished product.
